(19) United States
(12) Patent Application Publication
(10) Pub. No.: US 2024/0269627 A1
(43) Pub. Date: Aug. 15, 2024

(54) SYSTEM FOR MIXING LIQUID AND POWDER

(71) Applicant: REICA CO., LTD., Miyazaki (JP)

(72) Inventor: Toru TANIGUCHI, Miyazaki (JP)

(73) Assignee: REICA CO., LTD., Miyazaki (JP)

(21) Appl. No.: 18/567,335

(22) PCT Filed: Dec. 22, 2022
(86) PCT No.: PCT/JP2022/047312

§ 371 Date: Dec. 5, 2023

(30) Foreign Application Priority Data
Dec. 23, 2021 (JP) 2021-209353

(51) Int. Cl. B01F 23/50; B01F 25/10; B01F 25/50; B01F 35/22; B01F 35/221; B01F 35/75

(52) U.S. Cl. CPC B01F 23/59; B01F 23/56; B01F 25/103; B01F 25/1042; B01F 25/50; B01F 35/2202; B01F 35/2211; B01F 35/7544

(57) ABSTRACT

The present invention provides a mechanism in which the power of a vortex flow can be maintained strong so as to efficiently mix a liquid and a powder. A system for mixing liquid and powder according to the present embodiment is provided with: a powder-liquid mixing unit 20 which has a casing 21 for accommodating therein a powder and a liquid to be mixed together and discharges a mixture from an outlet opening 27 at the bottom of the casing 21; a powder supply unit 10 which is disposed above the powder-liquid mixing unit 20 and supplies a powder to the casing 21; an injection unit 22 which is provided at an upper portion of the casing 21 and injects a liquid into the casing; and a first pump 30 which is connected to the outlet opening 27 of the casing 21 and suctions the mixture inside the casing.

### TECHNICAL FIELD

The present invention relates to a powder liquid mixing system for mixing a powder and a liquid.

### BACKGROUND ART

Various types of powder liquid mixing systems have been developed in order to manufacture products by mixing a powder and a liquid according to the prior art. For example, Patent Literature 1 discloses a device where a vortex flow of a liquid is generated within a cylindrical container into which a powder to be mixed is supplied from a supply shaft that is arranged to be coaxial with the pivot for the vortex flow (axis of the cylindrical container).

In addition, Patent Literature 2 discloses a muddy water treatment device having an infiltration unit where a powder coagulant is put into a tank into which muddy water resulting from civil engineering work is supplied so that the coagulant is infiltrated with water so as to be dissolved. It is also disclosed that a vortex flow is generated within the tank when muddy water flows into the tank in the direction along the peripheral wall of the tank, and the muddy water flows out from the center portion at the bottom surface of the tank.

### CITATION LIST

### Patent Literature

Patent Literature 1: Japanese Unexamined Patent Publication 2019-147104
Patent Literature 2: Japanese Unexamined Patent Publication 2006-181400

### SUMMARY OF THE INVENTION

### Technical Problem

In order to efficiently mix a powder and a liquid, as shown in Patent Literature 1, it is effective to create a vortex flow by rotating a liquid and to cast a powder into the vortex flow. In the case where the force of the vortex flow is weak, the flow directed from the surface of the vortex towards the inside of the vortex becomes weak, and thus, the working effects of taking the powder from the surface of the vortex to the inside of the vortex becomes weak. As a result, some powder stays in the vicinity of the center of the surface of the vortex, which prevents the mixture between the powder and the liquid from proceeding. Therefore, it is important to maintain the state where the force of the vortex flow is strong in powder liquid mixing systems using a vortex flow.

In the case where a vortex flow is generated within a tank as in Patent Literature 2, it is necessary to continually allow a certain amount or more of muddy water to flow into a tank, and a certain amount or more of muddy water to flow out of the tank in order to maintain the vortex flow within the tank. In the case where muddy water is continually allowed to flow in and flow out in this manner, it is difficult to maintain the mixture ratio between the powder coagulant and the muddy water at a constant level, and in addition, muddy water cannot help but be discharged even in a state where the coagulant is not sufficiently mixed into the muddy water, and thus, the mixture becomes unstable.

In order to solve the problem, an object of the present invention is to provide a powder liquid mixing system using a vortex flow with a mechanism that makes it possible to maintain the state where the force of the vortex flow is strong so that a powder and a liquid can be mixed efficiently.

### Solution to Problem

In order to achieve the above object, the system for mixing a liquid and a powder according to the present invention has the below-described technical features.

That is to say, the system for mixing a liquid and a powder according to the present invention is provided with: a powder liquid mixing unit having a casing for containing a powder and a liquid to be mixed together, where the mixture can be discharged through an outlet opening in a lower portion of the casing; a powder supply unit that is arranged on an upper side of the powder liquid mixing unit and that can supply a powder to the casing; an injection unit that is provided in an upper portion of the casing and that can inject a liquid into the casing; a first pump that is connected to the outlet opening and that can suck in the mixture from the inside of the casing; and a circulation path that can supply at least part of the mixture that has been sucked in by the first pump to the injection unit so that that part of the mixture can be reintroduced into the casing, characterized in that a vortex flow of the mixture is created within the casing when the injection unit injects a liquid or a mixture and when the first pump sucks in the mixture, and the supply amount of the liquid and the discharge amount of the mixture that is discharged from the circulation path via a branched portion thereof are controlled in order to adjust the level of the upper surface of the mixture within the casing so that the injection unit can be arranged in a place that is higher than the level of the upper surface of the mixture within the casing.

In addition, the above-described system for mixing a liquid and a powder is further provided with a sensor for detecting the level of the upper surface of the mixture within the casing, and the configuration makes the above-described control possible on the basis of the detection results by the sensor.

Furthermore, the above-described system for mixing a liquid and a powder is provided with a configuration where the casing has a conical shape that gradually tapers toward the outlet opening.

Moreover, the above-described system for mixing a liquid and a powder is provided with a configuration having an additional mixing unit into which the mixture that has been discharged from the powder liquid mixing unit can be reintroduced via the branched portion for a further mixing operation.

In addition, the above-described system for mixing a liquid and a powder is provided with a configuration having a second pump that can additionally suck in at least part of the mixture that has been sucked in by the first pump.

Furthermore, the above-described system for mixing a liquid and a powder is provided with a configuration where the amount of the liquid supplied to the injection unit can be adjusted in response to the amount of the mixture that has been sucked in by the second pump.

### Advantageous Effects of the Invention

The present invention provides: a powder liquid mixing unit having a casing for containing a powder and a liquid to be mixed together, where the mixture can be discharged through an outlet opening in a lower portion of the casing; a powder supply unit that is arranged on an upper side of the powder liquid mixing unit and that can supply a powder to the casing; an injection unit that is provided in an upper portion of the casing and that can inject a liquid into the casing; a first pump that is connected to the outlet opening and that can suck in the mixture from the inside of the casing; and a circulation path that can supply at least part of the mixture that has been sucked in by the first pump to the injection unit so that that part of the mixture can be reintroduced into the casing, in such a manner that a vortex flow of the mixture is created within the casing when the injection unit injects a liquid or a mixture and when the first pump sucks in the mixture, and the supply amount of the liquid and the discharge amount of the mixture that is discharged from the circulation path via a branched portion thereof are controlled in order to adjust the level of the upper surface of the mixture within the casing so that the injection unit can be arranged in a place that is higher than the level of the upper surface of the mixture within the casing, and therefore, the state where the force of the vortex flow is strong can be maintained, which makes it possible to efficiently mix the powder and the liquid.

### BRIEF DESCRIPTION OF DRAWINGS

FIG. 1 is a diagram showing an example of the configuration of the system for mixing a liquid and a powder according to one embodiment of the present invention;

FIG. 2 is a diagram showing an example of the configuration of an additional mixing unit; and

FIG. 3 is a diagram showing an example of the configuration of a pump for sucking in from a pipe the mixture to be introduced into the additional mixing unit.

### DESCRIPTION OF EMBODIMENTS

In the following, the system for mixing a liquid and a powder according to the present invention is described in reference to the drawings.

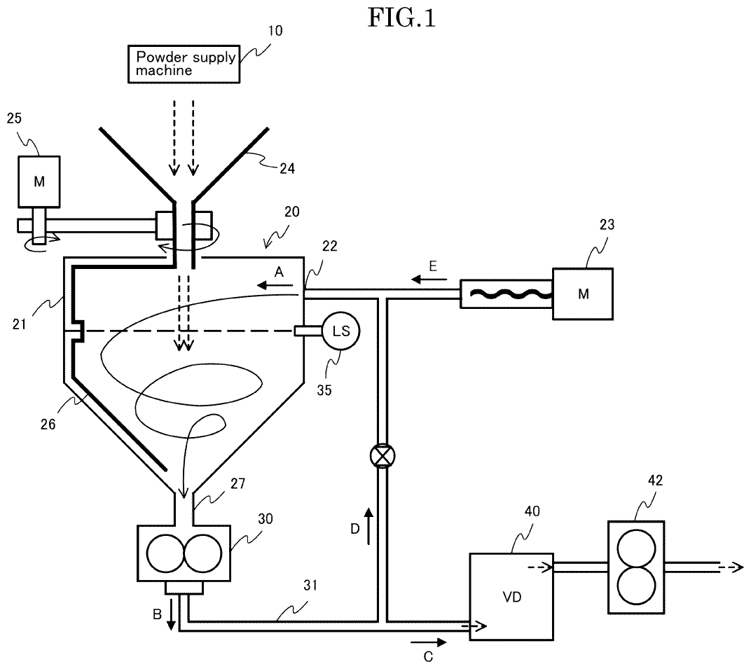

FIG. 1 is a diagram showing an example of the configuration of the system for mixing a liquid and a powder according to one embodiment of the present invention.

Conceptually speaking, the system for mixing a liquid and a powder in the present embodiment has a configuration that is provided with a powder liquid mixing unit 20 for mixing a powder and a liquid and an additional mixing unit 40 for additionally mixing the mixture of the powder and the liquid that has been mixed in the powder liquid mixing unit 20. The system for mixing a liquid and a powder in the present embodiment can be used for mixing various types of powders and various types of liquids, and for example, is used for mixing polyvinyl alcohol (powder) and water (liquid).

The powder liquid mixing unit 20 has a casing 21 for containing a powder and a liquid that are to be mixed together. The casing 21 is cylindrical on the upper side, and the lower side thereof is formed in such a manner that the inner wall gradually tapers toward the outlet opening 27 in the lower portion. In FIG. 1, the lower side of the casing 21 is formed to be conical; however, other shapes may be possible as long as the shape allows the fluid inside the casing to easily generate a vortex flow.

An injection unit 22 for injecting a liquid into the casing is provided in a portion of the wall in the upper portion of the casing 21. The injection unit 22 injects the liquid that is supplied from the liquid supply source, not shown, into the casing through the working effects of the pump 23. As described below, it is possible for the injection unit to inject not only a liquid from the liquid supply source, but also the mixture together with the liquid. In the present embodiment, the liquid that has been injected in the direction along the periphery of the casing 21 moves along the inner peripheral surface of the casing 21; however, other injection systems may be used as long as a liquid can be injected in such a manner that a vortex flow can be easily generated in the liquid within the casing. Here, one injection unit 22 is provided; however, a plurality of injection units 22 may be provided in different locations along the inner periphery surface of the casing 21.

The liquid that has been injected into the casing from the injection unit 22 moves along the inner peripheral surface of the casing 21 while gradually moving downward due to its own weight. As a result, the liquid that has been introduced into the casing generates a vortex flow inside the casing 21.

A powder supply unit 10 for supplying a powder to the powder liquid mixing unit 20 is arranged on the upper side of the powder liquid mixing unit 20. Various types of supplying devices can be used as the powder supply unit 10. For example, the supplying device that is disclosed in Japanese Patent Application 2021-87500 can be used as the powder supply unit 10.

The powder that is supplied from the powder supply unit 10 is poured into the inside of the casing 21 through a funnel-shaped hopper 24 that is provided on the upper side of the casing 21. The hopper 24 is arranged so that the axis thereof becomes approximately coaxial to that of the casing 21 so that the powder can be poured down into the center or in the vicinity thereof of the vortex flow within the casing from the opening in the lower portion of the hopper 24. The hopper 24 can be rotated at a low speed by means of the motor 25 that is connected to the hopper 24 so that the powder within the hopper drops naturally into the casing 21 through the opening in the lower portion.

In the present embodiment, the technology disclosed in Japanese Unexamined Patent Publication 2015-3290 is applied to the hopper 24. That is to say, a scraper 26 having a blade of which the contour follows the cross-section of the casing 21 is fixed to the lower portion around the hopper opening in such a manner that the scraper 26 rotates as the hopper 24 rotates. As a result, even in the case where the powder that has been poured into the casing 21 absorbs the moisture from its surroundings and adheres to the inner wall of the casing 21, it becomes possible for the scraper 26 to scrape off the powder. Naturally, it is also possible for the present invention to adopt a configuration where the motor 25 or the scraper 26 is not used.

The powder that has been poured into the casing drops onto the surface of the vortex flow and is gradually taken into the vortex flow so as to be mixed with the liquid. In addition, the vortex flow rolls in the powder that floats on the surface before it takes the powder into the vortex flow, and therefore has such effects that the amount of the gas that is mixed is small. Here, the operation of the vortex flow of taking in the powder is the most effective in the vicinity of the center where the flow of the vortex is the fastest. In the case where the force of the vortex flow is weak, however, the operation of taking in the powder is weak even in the vicinity of the center. In this case, the powder is collected on the surface in the vicinity of the center of the vortex, which prevents the mixture from progressing. Therefore, a pump 30 for sucking in the mixture within the casing is connected to the outlet opening 27 in the lower portion of the casing 21 in order to increase the force of the vortex flow within the casing. The sucking operation of the pump 30 increases the force of the vortex flow, and thus, a mixture with the liquid can be generated by efficiently taking the powder into the vortex flow. It also becomes possible to more effectively maintain the strong vortex flow due to the synergetic effects of the operation of injecting the liquid or the mixture from the above-described injection unit 22 and the sucking operation of the pump 30.

An additional mixing unit 40 for further mixing the mixture that has been discharged from the powder liquid mixing unit 20 is connected to the pump 30 on the downstream side through a pipe 31. Various types of mixing devices can be used as the additional mixing unit 40. For example, an agitation mixing device (so-called “vibro mixer”) can be used as the additional mixing unit 40. An exemplary structure of a vibro mixer is provided with: a casing equipped with a flow path through which a liquid flows along the inside; and an agitator made up of a shaft that is connected to a vibration source and agitating blades that are attached to the periphery of the shaft, where the agitator that is arranged within the casing is vibrated in the axis direction so that agitation can be accelerated.

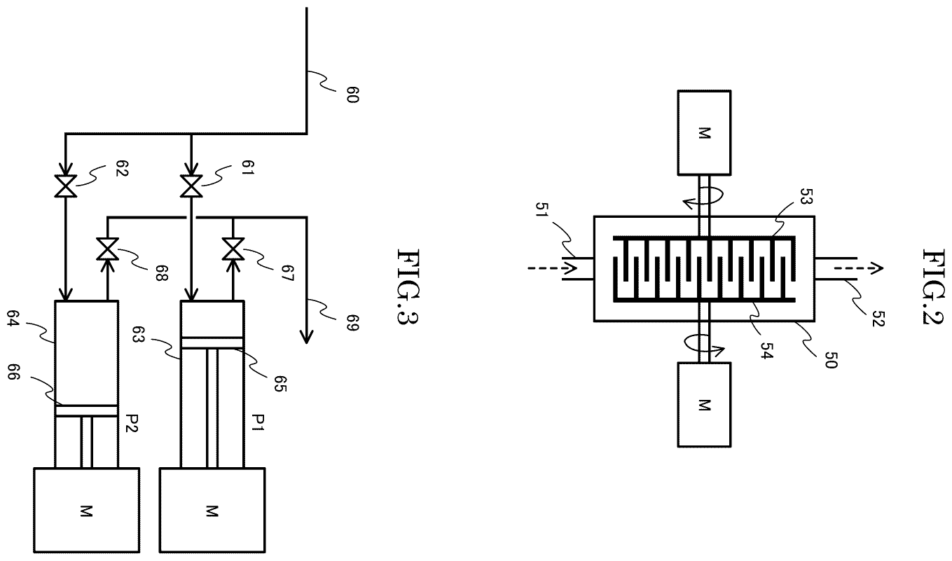

Alternatively, a rotary-type mixing device (so-called “pin mixer”) may be used as the additional mixing unit 40 as shown in FIG. 2. In the pin mixer in the figure, two rotational plates 53 and 54 are arranged within a housing 50 in disc form so as to face each other. The rotational plate 53 is rotated in a predetermined direction by means of a motor, and the rotational plate 54 is rotated in the opposite direction to the rotational plate 53 by means of another motor. A plurality of pins (protrusions) is provided on the surfaces of the rotational plates 53 and 54 on the sides that face each other. The housing 50 has an introduction opening 51 for the mixture in a portion of the peripheral surface, and has an outlet opening 52 for the mixture on the opposite side.

The mixture that has been introduced into the housing through the introduction opening 51 passes between the two rotational plates 53 and 54 that rotate in the opposite directions and repeatedly make fierce collisions with the pins while moving towards the outlet opening 52 so as to be mixed. In addition, the inner temperature increases as the fierce mixture due to the high-speed rotations of the rotational plates 53 and 54 continues. Therefore, this is effective for mixing the mixture that requires heating. The additional mixing unit 40 is not limited to these configurations, and a mixing device having a different configuration may be used.

There is a branched portion in the middle of the pipe 31 that connects the pump 30 to the additional mixing unit 40, and this configuration allows the mixture within the pipe to be divided into the injection unit 22. That is to say, the pipe 31 forms a circulation path through which part of the mixture that has been discharged from the powder liquid mixing unit 20 is reintroduced into the powder liquid mixing unit 20 from the injection unit 22. Accordingly, part of the mixture that has been discharged from the powder liquid mixing unit 20 is further mixed in the additional mixing unit 40, whereas the rest is reintroduced into the powder liquid mixing unit 20 from the injection unit 22. In the following description, the liquid that is injected from the injection unit 22 may include the mixture that has been circulated through the pipe 31.

A pump 42 for sucking in the mixture from a branched portion of the pipe 31 and introducing the sucked mixture to the additional mixing unit 40 is connected to the additional mixing unit 40 on the downstream side. The pump 42 may be provided to the additional mixing unit 40 on the upstream side (that is to say, between the pipe 31 and the additional mixing unit 40); however, the sucking operation of the pump 42 can be mitigated by the additional mixing unit 40 when the pump 42 is provided to the additional mixing unit 40 on the downstream side, and thus, the effects on the powder liquid mixing unit 20 can be suppressed. In addition, an agitation mixing device such as a vibro mixer or a rotation-type mixing device such as a pin mixer is appropriately used as the additional mixing unit 40 where a space is created in such a manner that the inlet and the outlet of the mixture are connected in order to effectively apply the sucking operation of the pump 42 to the branched portion. As for the pump 42, a gear pump can be used, for example.

As shown in FIG. 3, a piston-type pump may be used as the pump 42. The piston-type pump in FIG. 3 continually introduces a mixture while driving two cylinder pumps P1 and P2 reciprocally and sends out the mixture while applying pressure. In FIG. 4, the mixture that has been introduced through a pipe 60 on the input side is divided into two so as to be introduced to the cylinder pumps P1 and P2 via the valves 61 and 62. The respective cylinder pumps are formed of cylinders 63 and 64 and pistons 65 and 66 that reciprocate within these cylinders. When the piston 65 or 66 has moved to the right side in FIG. 3, the mixture is introduced into the cylinder 63 or 64. Conversely, when the piston 65 or 66 has moved to the left side, the mixture is discharged from within the cylinder 63 or 64. The discharged mixture is fed out to the pipe 69 on the output side via the valve 67 or 68. In this piston-type pump, the flow amount of the mixture that passes through each valve can be measured in order to more precisely measure the amount of the mixture sucked in by the pump 42, and therefore, it becomes possible to enhance the precision of the below-described flow amount control.

In the case where the level of the upper surface of the mixture within the casing is lower than the injection unit 22, the liquid that has been injected into the space within the casing from the injection unit 22 revolves along the inner peripheral surface of the casing 21 while moving down due to its own weight, and thus merges with the vortex flow in the state where the force thereof has been increased. Meanwhile, in the case where the level of the upper surface of the mixture within the casing exceeds the injection unit 22, the liquid is directly injected into the vortex flow from the injection unit 22. In this case, the force of the liquid that has been injected from the injection unit 22 is weaker at the time when merging with the vortex flow as compared to the case where the liquid is injected into the space within the casing. As a result, the state where the force of the vortex flow is strong cannot be maintained, and the working effects of the vortex flow that drags the powder into the liquid for mixing become weak.

As a measure against this, the powder liquid mixing system in the present embodiment is provided with a mechanism for controlling the system in such a manner that the level of the upper surface of the mixture within the casing does not exceed the injection unit 22. Concretely, a sensor 35 for detecting the level of the upper surface of the mixture within the casing is provided, and thus, the configuration allows at least either the amount A of the liquid that is injected from the injection unit 22 or the amount B of the mixture sucked in by the pump 30 to be controlled on the basis of the detection results of the sensor 35. In order to control the level of the upper surface of the mixture more precisely, it is necessary to take into consideration the supply amount of the powder that is supplied to the casing; however, the control that focuses on the liquid or the mixture is mainly described in the following. In order to take into consideration the effects of the supplied powder, the degrees of changes in the volumes of the liquid, the powder, and the mixture are determined in advance when the supply amount of the supplied powder (unit may be weight or volume) is mixed with the liquid, and thus, the change in the level of the upper surface of the mixture within the casing (change in the volume of the mixture within the casing) is controlled together with the supply of the powder, and as a result, more precise control becomes possible.

The level of the upper surface of the mixture that is detected by the sensor 35 can be different in accordance with the sensing system, where the location of the detected level may be in the peripheral portion of the vortex flow, in the center portion of the vortex flow, or in the middle portion between these. The point is that it can be detected that the level of the upper surface of the mixture within the casing has approached the height that is close to the injection unit 22 so that the injection unit 22 is not drawn into the vortex flow.

For example, the sensor 35 is arranged on the side lower than the injection unit 22 so that it can be detected that the level of the upper surface of the mixture within the casing has reached the position of the sensor. Thus, when it is detected that the level of the upper surface of the mixture within the casing has reached the position of the sensor, a control unit, not shown, controls at least either the amount A of the liquid that is injected from the injection unit 22 or the amount B of the mixture that is sucked in by the pump 30. Concretely, the control of reducing the amount A of the liquid that is injected from the injection unit 22, the control of increasing the amount B of the mixture that is sucked in by the pump 30, or the control of both of these is carried out. The amount A of the injected liquid is the sum of the amount E of the liquid that is supplied from the liquid supply source and the amount D of the returned mixture that is supplied via the circulation path (A=E+D). In addition, the amount D of the returned mixture represents the value that is gained by subtracting the amount C of the mixture that is sucked in by the additional mixing unit via the branched portion from the amount B of the sucked mixture (D=B−C). Therefore, to control the amount A of the injected liquid or the amount B of the sucked mixture means to control the amount E of the supplied liquid or the amount C of the sucked mixture.

As a result, the amount of the liquid introduced into the powder liquid mixing unit 20 (supply amount E) and the amount of the mixture discharged from the powder liquid mixing unit 20 (suction amount C) can be balanced, and thus, the level of the upper surface of the mixture can be prevented from exceeding the injection unit 22. Accordingly, the state where the force of the vortex flow is strong can be maintained, and thus, it is possible to efficiently mix the powder and the liquid. As described above, it is naturally desirable to take the amount of the supplied powder into consideration in order to control the level of the upper surface more precisely.

In the powder liquid mixing system in the present embodiment, part of the mixture that has been discharged from the powder liquid mixing unit 20 is introduced into the additional mixing unit 40 for further mixing, whereas the rest is reintroduced into the powder liquid mixing unit 20 from the injection unit 22. That is to say, not only the liquid that is supplied from the liquid supply source (not shown), but also part of the mixture that has been discharged from the powder liquid mixing unit 20 is introduced to the powder liquid mixing unit 20. Accordingly, the amount A of the liquid that is injected from the injection unit 22 is determined by the amount C of the mixture that is sucked in by the pump 42 (or the amount D of the mixture that is returned to the injection unit 22) and the amount E of the liquid that is supplied from the liquid supply source (not shown).

Therefore, the adjustment of the supply amount E of the liquid that is supplied to the injection unit 22 from the liquid supply source (not shown) is controlled in accordance with the amount C of the mixture that is sucked in by the pump 42. In the case where the amount C of the mixture that is sucked in by the pump 42 is increased, for example, the amount D of the mixture that is returned to the injection unit 22 is reduced, and therefore, in order to compensate for this, the amount E of the liquid that is supplied from the liquid supply source (not shown) is increased. In addition, in the case where the amount C of the mixture that is sucked in by the pump 42 is reduced, the amount D of the mixture that is returned to the injection unit 22 increases, and therefore, the amount E of the liquid that is supplied from the liquid supply source (not shown) is reduced by that amount. As a result, even in the case where the amount C of the mixture that is sucked in by the pump 42 changes, the amount A of the liquid that is injected from the injection unit 22 can be constantly maintained.

In the case where the amount A of the liquid that is injected from the injection unit 22 is changed, at least either the amount C of the mixture that is sucked in by the pump 42 or the amount E of the liquid that is supplied from the liquid supply source (not shown) may be controlled. For example, the control of increasing the amount C of the mixture that is sucked in by the pump 42 (that is to say, the control of reducing the amount D of the mixture that is returned to the injection unit 22), the control of reducing the amount E of the liquid that is supplied from the liquid supply source (not shown) or the control of both of these is carried out so that the amount A of the liquid or the mixture that is injected from the injection unit 22 can be reduced. In addition, the controls opposite these can be carried out so that the amount A of the liquid or the mixture that is injected from the injection unit 22 can be increased.

As described above, the powder liquid mixing system in the present embodiment is provided with: a powder liquid mixing unit 20 that has a casing 21 for containing a powder and a liquid to be mixed together and that discharges the mixture from an outlet opening 27 in a lower portion of the casing 21; a powder supply unit 10 that is arranged on the upper side of the powder liquid mixing unit 20 and that supplies a powder to the casing 21; an injection unit 22 that is provided in an upper portion of the casing 21 and that injects a liquid (including a mixture in the case where the mixture is returned) into the casing; and a pump 30 that is connected to the output opening 27 in the casing 21 and that sucks in the mixture from within the casing, where the configuration controls at least either the amount A of the liquid that is injected from the injection unit 22 or the amount B of the mixture that is sucked in by the pump 30 so that the level of the upper surface of the mixture within the casing can be adjusted. This configuration can maintain the state where the force of the vortex flow is strong, and thus makes it possible to efficiently mix the powder and the liquid together.

In addition, in the powder liquid mixing system in the present embodiment, the injection unit 22 is arranged in a place that is higher than the level of the upper surface of the mixture within the casing. As a result, the liquid that is injected into the space within the casing from the injection unit 22 revolves along the inner periphery surface of the casing 21 while moving down due to its own weight, and thus merges with the vortex flow in the state where the force thereof has been increased, which makes it possible to create a vortex flow having a strong force.

In addition, the powder liquid mixing system in the present embodiment is provided with a sensor 35 for detecting the level of the upper surface of the mixture within the casing, and the configuration controls the amount A of the liquid that is injected from the injection unit 22 or the amount B of the mixture that is sucked in by the pump 30 on the basis of the detection results of the sensor 35. As a result, it can be detected that the level of the upper surface of the mixture within the casing has reached a predetermined height, which makes it possible to carry out the above-described control using an appropriate timing.

Furthermore, the powder liquid mixing system in the present embodiment is provided with a configuration where at least part of the mixture that is sucked in by the pump 30 is supplied to the injection unit 22. As a result, not only the liquid from the liquid supply source (not shown), but also the mixture that is sucked in by the pump 30 is injected from the injection unit 22, and therefore, it is possible to efficiently strengthen the force of the liquid that is injected from the injection unit 22. Even in the case where the mixing within the casing is insufficient, it becomes possible to repeatedly supply the mixture into the casing to make the mixing more uniform by allowing the circulation path to return the mixture.

Moreover, the powder liquid mixing system in the present embodiment is provided with an additional mixing unit 40 for further mixing the mixture that has been discharged from the powder liquid mixing unit 20. As a result, the mixture can be further mixed appropriately, which makes it possible to enhance the mixing efficiency.

In addition, the powder liquid mixing system in the present embodiment is provided with a second pump 42 for further sucking in at least part of the mixture that has been sucked in by the first pump 30, and thus, the configuration adjusts the amount E of the liquid that is supplied to the injection unit 22 in accordance with the amount C of the mixture that is sucked in by the second pump 42. As a result, it becomes possible to constantly maintain the amount A of the liquid that is injected from the injection unit 22 even when the amount C of the mixture that is sucked in by the second pump 42 changes.

Though the present invention is described in reference to one embodiment of the present invention, the present invention is not limited to the above description, and needless to say, various modifications or changes in the design are possible as long as the gist of the present invention is not deviated from. For example, a powder is poured in the vicinity of the center of the vortex flow in the above description; however, the configuration may allow a powder to be poured in the vicinity of the periphery of the vortex flow.

In addition, in the case where the level of the upper surface of the mixture within the casing approaches the injection unit 22, the amount A of the liquid that is injected from the injection unit 22 is reduced or the amount B of the mixture that is sucked in by the pump 30 is increased under the control in the above description; however, the control opposite this may be carried out in the case where the level of the upper surface of the mixture is too low. That is to say, concerning the level of the upper surface of the mixture within the casing, for example, a sensor may be provided as well in the vicinity of the lower limit for a powder and a liquid to be efficiently mixed together. Thus, such a control may be carried out where the amount A of the liquid that is injected from the injection unit 22 is increased or the amount B of the mixture that is sucked in by the pump 30 is reduced in the case where the sensor has detected that the level of the upper surface has lowered in close proximity to the lower limit.

### INDUSTRIAL APPLICABILITY

The present invention is applicable in powder liquid mixing systems for mixing a powder and a liquid.

### REFERENCE SIGNS LIST

10: Powder supply unit
20: Powder liquid mixing unit
21: Casing
22: Injection unit
23: Pump
24: Hopper
25: Motor
26: Scraper
27: Outlet opening
30: First pump
31: Pipe
40: Additional mixing unit
42: Second pump
50: Housing
51: Introduction opening
52: Outlet opening
53, 54: Rotational plate
60: Pipe
61, 62: Valve
63, 64: Cylinder
65, 66: Piston
67, 68: Valve
69: Pipe

1. A system for mixing a liquid and a powder, comprising:
a powder liquid mixing unit having a casing for containing a powder and a liquid to be mixed together, where the mixture can be discharged through an outlet opening in a lower portion of the casing;
a powder supply unit that is arranged on an upper side of the powder liquid mixing unit and that can supply a powder to the casing;
an injection unit that is provided in an upper portion of the casing and that can inject a liquid into the casing;
a first pump that is connected to the outlet opening and that can suck in the mixture from the inside of the casing; and
a circulation path that can supply at least part of the mixture that has been sucked in by the first pump to the injection unit so that that part of the mixture can be reintroduced into the casing, characterized in that
a vortex flow of the mixture is created within the casing when the injection unit injects a liquid or a mixture and when the first pump sucks in the mixture, and
the supply amount of the liquid and the discharge amount of the mixture that is discharged from the circulation path via a branched portion thereof are controlled in order to adjust the level of the upper surface of the mixture within the casing so that the injection unit can be arranged in a place that is higher than the level of the upper surface of the mixture within the casing.

2. The system for mixing a liquid and a powder according to claim 1, characterized in that
the system further comprises a sensor for detecting the level of the upper surface of the mixture within the casing, and
the supply amount of the liquid and the discharge amount of the mixture are controlled on the basis of the detection results by the sensor.

3. The system for mixing a liquid and a powder according to claim 1, characterized in that the casing has a conical shape that gradually tapers toward the outlet opening.

4. The system for mixing a liquid and a powder according to claim 1, characterized in that the system further comprises an additional mixing unit into which the mixture that has been discharged from the powder liquid mixing unit is reintroduced via the branched portion for a further mixing operation.

5. The system for mixing a liquid and a powder according to claim 1, characterized in that the system further comprises a second pump that can additionally suck in at least part of the mixture that has been sucked in by the first pump.

6. The system for mixing a liquid and a powder according to claim 5, characterized in that the amount of the liquid supplied to the injection unit can be adjusted in response to the amount of the mixture that has been sucked in by the second pump.
